(19) United States
(12) Patent Application Publication
(10) Pub. No.: US 2015/0218424 A1
(43) Pub. Date: Aug. 6, 2015

(54) SURFACE PROTECTIVE SHEET SUBSTRATE AND SURFACE PROTECTIVE SHEET

(71) Applicant: NITTO DENKO CORPORATION, Osaka (JP)

(72) Inventors: Takeshi IGARASHI, Osaka (JP); Yasunori YAMAMOTO, Osaka (JP); Nao WAKAYAMA, Osaka (JP)

(73) Assignee: NITTO DENKO CORPORATION, Osaka (JP)

(21) Appl. No.: 14/611,502

(22) Filed: Feb. 2, 2015

(30) Foreign Application Priority Data
Feb. 5, 2014 (JP) 2014-020730

(51) Int. Cl. C09J 7/02; B32B 27/08; B32B 27/32

(52) U.S. Cl. CPC C09J 7/0296; B32B 27/32; B32B 27/08; B32B 2250/03; B32B 2250/242; C09J 2423/006

(57) ABSTRACT

Provided is a surface protective sheet substrate capable of forming a surface protective sheet endowed with both curling inhibition and adhesion mark inhibition. The surface protective sheet substrate provided by this invention comprises a polyolefin resin which accounts for more than 50% by weight of the entire substrate. The substrate comprises a layer X constituting a first surface of the substrate and a layer Y constituting the second surface of the substrate. The layer X is constituted with a resin composition having a tensile elastic modulus (E_{X}) of 400 MPa or greater, but 750 MPa or less. The layer Y is constituted with a resin composition having a tensile elastic modulus (E_{Y}) of 400 MPa or greater, but 750 MPa or less. The layer X has a thickness t_{X} and the layer Y has a thickness t_{Y}, satisfying 0.5≦t_{X}·E_{X}·t_{Y}·E_{Y}≦1.5.

### CROSS-REFERENCE

The present application claims priority based on Japanese Patent Application No. 2014-020730 filed on Feb. 5, 2014, and the entire content thereof is incorporated herein by reference.

### BACKGROUND OF THE INVENTION

1. Field of the Invention

The present invention relates to a surface protective sheet substrate and a surface protective sheet.

2. Description of the Related Art

During processing or transporting metal plates, painted steel plates, or synthetic resin plates, etc., as a known means to prevent their surfaces from receiving damages such as scratches, dirt deposits, etc., protective sheets are adhered to the surfaces. In general, such a surface protective sheet is temporarily adhered to an adherend while the adherend needs to be protected (e.g., during the process or transport, etc.). Subsequently, after use as a protective means, the surface protective sheet is removed from the adherend. A surface protective sheet used for such a purpose is generally constructed to comprise a pressure-sensitive adhesive (PSA) on a face of a substrate sheet (support substrate) so that it can serve the protection purpose when adhered via the PSA to an adherend (article to be protected). Technical literatures related to such surface protective sheets which are adhered for use to protect surfaces of articles include Japanese Patent Application Publication No. 2011-111552, Japanese Patent No. 4825508, and Japanese Patent Application Publication No. 2013-126743.

### SUMMARY OF THE INVENTION

Conventionally, for a support substrate used in a surface protective sheet, a resin film having a single-layer or multi-layer structure is mainly used. In particular, it is effective to construct the substrate to have a multi-layer structure formed of two or more layers, as means to bring about well-balanced, various physical properties (e.g. fracture strength, tensile elongation, rigidity, removability, tendency to leave adhesion marks) that are required of a surface protective sheet.

When a resin film comprising two or more layers with varied compositions is used as a support substrate in a surface protective sheet, however, there may occur curling of the support substrate or of the surface protective sheet using the substrate. For instance, in a process for manufacturing surface protective sheets, when an emulsion-based or solvent-based PSA composition is applied to the support substrate and allowed to dry on the support substrate to form a PSA layer on the support substrate surface, the heat applied to accelerate the drying is likely to cause curling of the substrate. The curling of the support substrate may hinder the production of surface protective sheets using the substrate or degrade the handling properties during application and/or removal of the surface protective sheets.

On the other hand, when removing the surface protective sheet from a protected adherend, to inhibit the PSA components from partially remaining (leaving adhesion marks) on the adherend surface, studies have been underway about the design of the resin composition constituting the PSA layer side surface of the substrate. However, with a constitution effective in inhibiting adhesion marks, the aforementioned curling was often more significant.

An objective of the present invention is to provide a substrate for use in a surface protective sheet capable of bringing about a surface protective sheet which is inhibited from curling and leaving adhesion marks. Another objective of the present invention is to provide a surface protective sheet comprising such a surface protective sheet substrate as a constituent.

### Solution to Problem

The surface protective sheet substrate disclosed herein comprises a polyolefin resin which accounts for more than 50% by weight of the entire substrate. The substrate comprises a layer X that is a resin layer constituting a first surface of the substrate and a layer Y that is a resin layer constituting the second surface of the substrate. The layer X is constituted with a resin composition that may have a tensile elastic modulus (or “E_{X}” hereinafter in MPa) of 400 MPa or greater, but 750 MPa or less. The layer Y is constituted with a resin composition that may have a tensile elastic modulus (or “E_{Y}” hereinafter in MPa) of 400 MPa or greater, but 750 MPa or less. When the layer X has a thickness t_{X} (μm) and the layer Y has a thickness t_{Y} (μm), the substrate satisfies the next inequality 0.5≦t_{X}·E_{X}/t_{Y}·E_{Y}≦1.5. With a surface protective sheet substrate having such a constitution, curling of a surface protective sheet using the substrate can be inhibited. Such a surface protective sheet may be effective in suppressing adhesion marks.

In a preferable embodiment of the surface protective sheet substrate disclosed herein, the layer X satisfies 3.5×10³ N/m≦t_{X}·E_{X}≦10×10³ N/m. The layer Y satisfies 3.5×10³ N/m≦t_{Y}·E_{Y}≦10×10³ N/m. A surface protective sheet substrate having such a constitution is preferable, for instance, from the standpoint of the ease of extruding the surface protective sheet substrate.

In a preferable embodiment of the surface protective sheet substrate disclosed herein, there is a difference of 1 μm or larger, but 20 μm or smaller between the thickness (t_{X}) of the layer X and the thickness (t_{Y}) of the layer Y. A surface protective sheet substrate having such a constitution may show great abilities to inhibit the curling of a surface protective sheet using the substrate, to suppress adhesion marks, and so on.

In a preferable embodiment of the surface protective sheet substrate disclosed herein, the thickness (t_{X}) of the layer X is smaller than the thickness (t_{Y}) of the layer Y. When used in an embodiment of a surface protective sheet comprising a PSA layer preferably on the layer Y-side surface, a surface protective sheet substrate having such a constitution may show greater abilities to inhibit the curling of a surface protective sheet using the substrate, to suppress adhesion marks, and so on.

In a preferable embodiment of the surface protective sheet substrate disclosed herein, the substrate comprises an intermediate layer between the layer X and the layer Y. The intermediate layer is preferably constituted with a resin composition having a tensile elastic modulus smaller than both the E_{X} and the E_{Y}. A surface protective sheet substrate having such a constitution may exhibit excellent surface conformability when used in an embodiment of a surface protective sheet using the substrate. The surface conformability herein refers to an ability to conform and adhere tightly to the surface structure of an adherend without rising or peeling.

In a preferable embodiment of the surface protective sheet substrate disclosed herein, the substrate comprises a linear low density polyethylene in at least either the layer X or the layer Y. A surface protective sheet substrate having such a constitution may have a great ability to suppress adhesion marks when used in a surface protective sheet comprising the substrate.

In a preferable embodiment of the surface protective sheet substrate disclosed herein, the substrate has an overall thickness smaller than 60 μm. Such a surface protective sheet substrate is preferable from the standpoint of fabricating a thinner surface protective sheet with the substrate.

In a preferable embodiment of the surface protective sheet substrate disclosed herein, the thickness (t_{X}) of the layer X and the thickness (t_{Y}) of the layer Y yield a total thickness accounting for 35% or more, but 75% or less of the overall thickness of the substrate. A surface protective sheet substrate having such a constitution is preferable since it readily allows taking advantage of the multi-layer structure and makes it meaningful to apply the present invention to inhibit curling.

The art disclosed herein provides a surface protective sheet that comprises a surface protective sheet substrate disclosed herein and a PSA layer placed on at least either the layer X or the layer Y in the surface protective sheet substrate. A surface protective sheet having such a constitution is inhibited from curling and thus is advantageous from the standpoint of the productivity and handling properties of the surface protective sheet. Accordingly, the surface protective sheet can be preferably used for surface protection of large articles such as building materials, vehicles, etc.

In a preferable embodiment of the surface protective sheet disclosed herein, the PSA layer is formed by a method that comprises a step of drying a PSA composition comprising a solvent or dispersion medium on the surface protective sheet substrate. Curling has hitherto been particularly likely to occur in the drying step. Thus, it is especially meaningful to apply the present invention to such a surface protective sheet.

### BRIEF DESCRIPTION OF THE DRAWINGS

FIG. 1 shows a cross-sectional view schematically illustrating an embodiment of the surface protective sheet substrate according to the present invention.

FIG. 2 shows a cross-sectional view schematically illustrating an embodiment of the surface protective sheet according to the present invention.

### DETAILED DESCRIPTION OF THE INVENTION

Preferred embodiments of the present invention are described below. Matters necessary to practice this invention other than those specifically referred to in this description may be understood as design matters based on the conventional art in the pertinent field for a person of ordinary skill in the art. The present invention can be practiced based on the contents disclosed in this description and common technical knowledge in the subject field.

In the following drawings, all members and sites providing the same effect are indicated by the same reference numeral, and redundant descriptions may be omitted or simplified. The embodiments in the drawings are schematically illustrated for clearly describing the present invention, and do not represent the dimensions or scales of the surface protective sheet substrate or surface protective sheet of the present invention that are actually provided as products.

The surface protective sheet substrate disclosed herein comprises a layer X that is a resin layer constituting a first surface of the substrate and a layer Y that is a resin layer constituting the second surface (the opposite surface from the first surface) of the substrate. The surface protective sheet substrate may have a two-layer structure consisting of the layer X and the layer Y or may further comprise an intermediate layer between the layer X and the layer Y. In a surface protective sheet substrate comprising the intermediate layer, the number of intermediate layers may be one, two or more. The upper limit of the number of intermediate layers is not particularly limited. From the standpoint of the productivity of the surface protective sheet substrate, etc., the number of intermediate layers is usually preferably 5 or fewer, or more preferably 3 or fewer. The compositions of the respective layers in the surface protective sheet substrate may be the same with or different from one another.

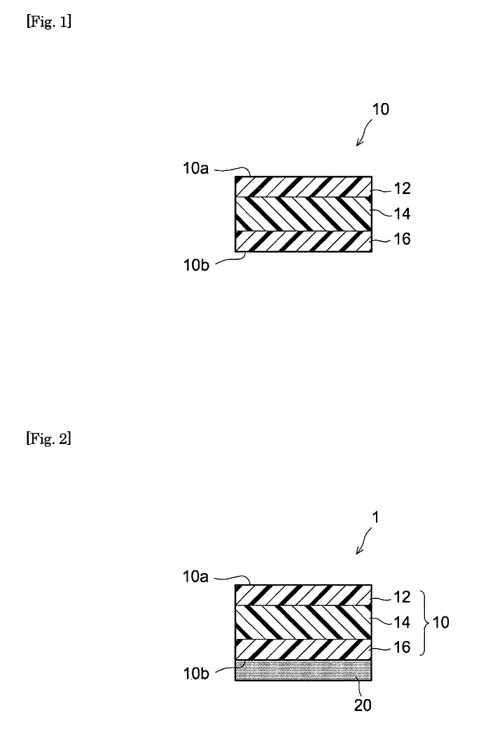

As a preferable embodiment of the surface protective sheet substrate disclosed herein, can be cited a constitution as schematically illustrated in FIG. 1, which has a three-layer structure including a layer X 12 which is a resin layer constituting a first surface 10a of a surface protective sheet substrate 10, a layer Y 16 which is a resin layer constituting the second surface 10b of the substrate 10, and a single intermediate layer 14 provided between the layer X 12 and layer Y 16.

The surface protective sheet substrate disclosed herein is preferably used in an embodiment of a surface protective sheet having a PSA layer on a first surface of the substrate. The PSA layer may be adjacent to either the layer X or the layer Y, but preferably adjacent to the layer Y. For instance, as schematically illustrated in FIG. 2, in a preferable embodiment of the surface protective sheet disclosed herein, surface protective sheet 1 may have a constitution where a PSA layer 20 is provided on the surface of the layer Y 16 (i.e. on the second surface 10b of surface protective sheet substrate 10).

When the surface protective sheet 1 is used, PSA layer 20 is adhered to an adherend (article to be protected). Surface protective sheet 1 prior to use (i.e. before adhered to the adherend) may have a form where the surface (adhesive face) of PSA layer 20 is protected with a release liner (not shown in the drawing) having a release face at least on the PSA layer side. Alternatively, it may have a form where the first surface (back face) 10a of substrate 10 is a release face and the surface protective sheet 1 is wound in a roll so that the back face 10a contacts and protects the surface of PSA layer 20.

### [Resin Component]

The surface protective sheet substrate disclosed herein is typically constituted as a resin film comprising two or more resin layers. The resin film is typically non-porous. The term “non-porous resin film” referred to herein should be conceptually distinguished from the so-called non-woven fabric (i.e., meaning to exclude non-woven fabrics). Such resin film may be obtained, for instance, by molding into a form of film a resin composition comprising a resin component as a primary component.

Examples of the resin component constituting the resin film include polyolefin-based resins such as a polyethylene (PE) resin, polypropylene (PP) resin, ethylene-propylene copolymer resin, etc.; polyester-based resins such as a polyethylene terephthalate (PET) resin, etc.; vinyl chloride-based resins; vinyl acetate-based resins; polyimide-based resins; polyamide-based resins; fluorine-based resins; and the like.

The resin components constituting the respective resin layers may have the same composition or different compositions. For instance, the substrate may comprise multiple resin layers having essentially the same resin composition, but different compositions of additives (weathering stabilizer, filler, etc.) from one another.

As the surface protective sheet substrate in the art disclosed herein, a resin film comprising a polyolefin-based resin as a primary component (e.g. a component contained in the substrate, accounting for more than 50% by weight) can be preferably used. A substrate having such a composition is preferable also from the standpoint of recyclability, etc. For instance, as the polyolefin-based resin, a resin film comprising one or each of a PE resin and a PP resin can be preferably used. In other words, in the surface protective sheet substrate, the total amount of the PE resin and PP resin may exceed 50% by weight of the entire substrate.

The primary component of the PP resin can be a polymer (a propylene-based polymer) of various types that contains propylene as a constituent. It can be a PP resin consisting essentially of one, two or more species of propylene-based polymer. The concept of the propylene-based polymer referred to herein include, for instance, the following polypropylenes:

Propylene homopolymer (homopolypropylenes) such as isotactic polypropylenes.

Random copolymers (random polypropylenes) of propylene and other α-olefin(s) (typically, one, two or more species selected from ethylene and α-olefins having 4 to 10 carbon atoms); preferably random polypropylenes constituted with propylene as the primary monomer (a main monomer, i.e., a component accounting for more than 50% by weight of all monomers); for instance, a random polypropylene obtained by random copolymerization of 96 to 99.9 mol % of propylene and 0.1 to 4 mol % of another α-olefin (preferably ethylene and/or butene).

Block copolymers (block polypropylenes) comprising a copolymer (preferably a copolymer wherein the primary monomer is propylene) obtained by block copolymerization of propylene and other α-olefin(s) (typically, one, two or more species selected from ethylene and α-olefins having 4 to 10 carbon atoms), and typically, further comprising as a by-product of the block copolymerization a rubber formed of at least either one of propylene and the other α-olefin; for instance, a block polypropylene comprising a polymer obtained by block copolymerization of 90 to 99.9 mol % of propylene and 0.1 to 10 mol % of other α-olefin(s) (preferably ethylene and/or butene), and further comprising as a by-product a rubber formed of at least either one of propylene and the other α-olefin.

The PP resin can be formed essentially of one, two or more species of such propylene-based polymer, or can be a thermoplastic olefin resin (TPO) or a thermoplastic elastomer (TPE) of a reactor blend type obtainable by copolymerizing a propylene-based polymer with a large amount of a rubber component, or of a dry blend type obtainable by mechanically dispersing the rubber component in a propylene-based polymer.

Alternatively, it can be a PP resin comprising a copolymer of propylene and a monomer (functional monomer) containing other functional group(s) in addition to a polymerizing functional group, a PP resin obtained by copolymerizing such a functional monomer with a propylene-based polymer, or the like.

The primary component of the PE resin can be a polymer (an ethylene-based polymer) of various types that contains ethylene as a constituent. It can be a PE resin consisting essentially of one, two or more species of ethylene-based polymer. The ethylene-based polymer can be an ethylene homopolymer or a product of copolymerization of ethylene as the primary monomer and other α-olefin(s) (e.g. an α-olefin having 3 to 10 carbon atoms). Preferable examples of the α-olefin include propylene, 1-butene, 1-hexene, 4-methyl-1-pentene, 1-octene, and the like. It can be a PE resin comprising a copolymer of ethylene and a monomer (functional monomer) containing other functional group(s) in addition to a polymerizing functional group, a PE resin obtained by copolymerizing such a functional monomer with an ethylene-based polymer, or the like. Examples of a copolymer of ethylene and a functional monomer include ethylene-vinyl acetate copolymers (EVA), ethylene-acrylic acid copolymers (EAA), ethylene-methacrylic acid copolymers (EMAA), ethylene-methyl acrylate copolymers (EMA), ethylene-ethyl acrylate copolymers (EEA), ethylene-methyl methacrylate copolymers (EMMA), ethylene-(meth)acrylic acid (i.e., ethylene-acrylic acid, or ethylene-methacrylic acid) copolymers crosslinked by metal ions, and the like.

The density of the PE resin is not particularly limited, and it can be, for instance, about 0.9 g/cm³ to 0.94 g/cm³ (typically 0.91 g/cm³ to 0.93 g/cm³). Preferable PE resins include a low-density polyethylene (LDPE) and a linear low-density polyethylene (LLDPE). In the art disclosed herein, as the PE resin, an LLDPE can be preferably used.

It is preferable that one or each of the layer X and the layer Y comprises an LLDPE. In particular, when the substrate is used in an embodiment of a surface protective sheet having a PSA layer on a surface thereof, the layer (e.g. the layer Y) provided with the PSA layer preferably comprises the LLDPE. Such a surface protective sheet substrate may increase the anchoring at the interface between the substrate and the PSA layer and inhibit adhesion marks during removal of the surface protective sheet.

As a preferable embodiment of the surface protective sheet substrate disclosed herein, can be cited a substrate whose resin component essentially consists of a PE resin and/or a PP resin. The respective layers (e.g. a layer X, a layer Y, and an intermediate layer which is an optional constituent) constituting the substrate may be individually a layer whose resin component consists of a PE resin alone (a PE layer), a layer whose resin component consists of a PP resin alone (a PP layer), or a layer formed of a resin blend comprising a PE resin and a PP resin at an arbitrary ratio (a PE-PP layer). For instance, as the substrate, a substrate having a multi-layer structure and comprising multiple (preferably two, three or four) PE-PP layers comprising a PE resin and a PP resin at varied blend ratios can be preferably used.

The resin material(s) constituting the resin component of the substrate can be selected so as to give rise to an appropriate melt mass-flow rate (MFR) in view of the substrate production (film formation) method and production conditions. If necessary, a blend of two or more different kinds of resin materials can be used. Although not particularly limited, for instance, a resin material having a MFR of approximately 0.5 g/10 min to 80 g/10 min can be used. Herein, the MFR refers to a value measured based on JIS K 7210 by method A at a temperature of 230° C. at an applied load of 21.18 N. From the standpoint of reducing the thermal contraction, a resin material having a MFR of about 0.5 g/10 min to 10 g/10 min can be preferably used. The resin material can be a PE resin or a PP resin having a MFR in this range, or a resin material formed of a PP resin and a PE resin blended to have a MFR in this range.

In an embodiment of the surface protective sheet substrate disclosed herein, the resin composition constituting the layer X preferably has a tensile elastic modulus (E_{X}) of 400 MPa or greater, but 750 MPa or less. A surface protective sheet having an E_{X} of 400 MPa or greater is preferable, for instance, from the standpoint of the ease of molding during fabrication of the substrate by melt extrusion. A surface protective sheet substrate having an E_{X} of 750 MPa or less is preferable from the standpoint of the inhibition of curling. The E_{X} is more preferably 500 MPa or greater, but 740 MPa or less, or even more preferably 600 MPa or greater, but 700 MPa or less. For instance, it is preferably 650 MPa or greater, but 700 MPa or less. Alternatively, in an embodiment where inhibition of curling is yet more important, the E_{X} may also be 600 MPa or greater, but 650 MPa or less.

In an embodiment of the surface protective sheet substrate disclosed herein, the resin composition constituting the layer Y preferably has a tensile elastic modulus (E_{Y}) of 400 MPa or greater, but 750 MPa or less. A surface protective sheet having an E_{Y} of 400 MPa or greater is preferable, for instance, from the standpoint of the ease of molding during fabrication of the substrate by melt extrusion. When used in an embodiment of a surface protective sheet having a PSA layer on the surface of the layer Y, a surface protective sheet having an E_{Y} of 750 MPa or less may increase the anchoring at the interface between the substrate and the PSA layer. Stronger anchoring is preferable since it may suppress adhesion marks during removal of the surface protective sheet. The E_{Y} is more preferably 500 MPa or greater, but 740 MPa or less, or even more preferably 550 MPa or greater, but 700 MPa or less. For instance, it is preferably 600 MPa or greater, but less than 650 MPa.

Herein, the tensile elastic modulus of a resin composition in the present description refers to a tensile elastic modulus measured based on JIS K 7161, using as a measurement sample a single-layer resin film formed with the resin composition. More specifically, the tensile elastic modulus of the resin composition can be measured, for instance, by the method described later in the worked examples.

Although not particularly limited, the thickness (t_{X}) of the layer X is preferably 3 μm or larger, but 35 μm or smaller, more preferably 5 μm or larger, but 20 μm or smaller, or even more preferably 6 μm or larger, but 15 μm or smaller. For instance, it is preferably 6 μm or larger, but 12 μm or smaller. A surface protective sheet substrate with the t_{X} being equal to or below the aforementioned upper limit is advantageous from the standpoint of making the substrate thinner. A surface protective sheet substrate with the t_{X} being equal to or above the aforementioned lower limit is advantageous from the standpoint of the ease of molding. In a preferable embodiment, the surface protective sheet substrate disclosed herein can have a t_{X} of 6 μm or larger, but 10 μm or smaller (e.g. 7 μm or larger, but 9 μm or smaller).

Although not particularly limited, the thickness (t_{Y}) of the layer Y is preferably 3 μm or larger, but 35 μm or smaller, more preferably 5 μm or larger, but 25 μm or smaller, or even more preferably 6 μm or larger, but 20 μm or smaller. For instance, it is preferably 8 μm or larger, but 15 μm or smaller. A surface protective sheet substrate with the t_{Y} being equal to or below the aforementioned upper limit is advantageous from the standpoint of making the substrate thinner. A surface protective sheet substrate with the t_{Y} being equal to or above the aforementioned lower limit is advantageous from the standpoint of the ease of molding. In a preferable embodiment, the surface protective sheet substrate disclosed herein can have a t_{Y} of 10 μm or larger, but 14 μm or smaller (e.g. 11 μm or larger, but 13 μm or smaller).

In an embodiment of the surface protective sheet substrate disclosed herein, the product of the thickness of the layer X multiplied by the tensile elastic modulus of the resin composition constituting the layer X (t_{X}·E_{X}) is preferably 3×10³ N/m or greater, but 10×10³ N/m or less (more preferably 3.5×10³ N/m or greater, but 10×10³ N/m or less, yet more preferably 3.5×10³ N/m or greater, but 9×10³ N/m or less, particularly preferably 4×10³ N/m or greater, but 8×10³ N/m or less, e.g. 4.5×10³ N/m or greater, but 7.5×10³ N/m or less). A surface protective sheet substrate with the product of t_{X}·E_{X} being in the aforementioned range is preferable from the standpoint of the ease of extrusion of the substrate.

In an embodiment of the surface protective sheet substrate disclosed herein, the product of the thickness of the layer Y multiplied by the tensile elastic modulus of the resin composition constituting the layer Y (t_{Y}·E_{Y}) is preferably 3.5×10³ N/m or greater, but 10×10³ N/m or less (more preferably 4×10³ N/m or greater, but 10×10³ N/m or less, yet more preferably 5×10³ N/m or greater, but 9×10³ N/m or less, particularly preferably 6×10³ N/m or greater, but 8×10³ N/m or less). A surface protective sheet substrate with the product of t_{Y}·E_{Y} being in the aforementioned range is preferable from the standpoint of the ease of extrusion of the substrate.

When t_{X}·E_{X} and t_{Y}·E_{Y} satisfy a suitable relationship, the surface protective sheet substrate disclosed herein can bring about an effect of inhibiting the curing of the substrate. More specifically, from the standpoint of inhibiting the curling, it is preferable that the value determined by the next ratio t_{X}·E_{X}/t_{Y}·E_{Y} is 0.5 or greater, but 1.5 or less, for instance, greater than 0.5, but less than 1.4. The value of t_{X}·E_{X}/t_{Y}·E_{Y} is more preferably 0.6 or greater, but 1.3 or less, or yet more preferably 0.6 or greater, but 1.2 or less, for instance, 0.6 or greater, but 1.1 or less.

With respect to the surface protective sheet substrate disclosed herein, even when E_{X} and E_{Y} have different values due to different resin compositions of the layer X and layer Y, by suitably selecting and designing the thickness (t_{X}) of the layer X and the thickness (t_{Y}) of the layer Y to have a t_{X}·E_{X}/t_{Y}·E_{Y} value in the aforementioned preferable range, it can be provided as a surface protective sheet substrate less susceptible to curling during the manufacturing or use of surface protective sheets. For instance, curling may be greatly inhibited with the substrate even when, in order to increase the anchoring at the interface between the substrate and the PSA layer, the tensile elastic modulus of the resin composition constituting the layer (preferably the layer Y) that forms the surface on the PSA layer side is designed to be lower than the tensile elastic modulus of the resin composition constituting the layer (preferably the layer X) that forms the surface on the opposite side from the PSA layer. Thus, the art disclosed herein can bring about inhibition of curling along with various features such as suppression of adhesion marks with the surface protective sheet, etc.

In a preferable embodiment of the surface protective sheet substrate disclosed herein, at least either the layer X or the layer Y in the substrate is constituted with a resin composition comprising a resin mixture in which three or more species of polyolefin resin are blended. With such a resin composition, the tensile elastic modulus can be easily adjusted by the blend ratio of the three or more species of polyolefin resin. For instance, because the value of t_{X}·E_{X}/t_{Y}·E_{Y} can be easily controlled, a surface protective sheet substrate having such a constitution is advantageous from the standpoint of inhibiting the curing of the substrate.

The thickness (t_{X}) of the layer X and the thickness (t_{Y}) of the layer Y may be the same or different. The art disclosed herein can be implemented preferably in an embodiment having different t_{X} and t_{Y} values. In such an embodiment, the absolute value of the difference between t_{X} and t_{Y} (i.e. | t_{X}−t_{Y}|) is preferably 1 μm or greater, but 20 μm or less, more preferably 1.5 μM or greater, but 15 μm or less, or yet more preferably 2 μm or greater, but 10 μm or less, for instance, 3 μm or greater, but 5 μm or less. A surface protective sheet substrate with |t_{X}−t_{Y}| being equal to or above the aforementioned lower limit is preferable because while adhesion marks can be greatly suppressed, the value of t_{X}·E_{X}/t_{Y}·E_{Y} can be easily adjusted to be in the aforementioned preferable range. A surface protective sheet substrate with the difference between t_{X} and t_{Y} being equal to or below the aforementioned upper limit is advantageous from the standpoint of making the substrate thinner. The art disclosed herein can be practiced preferably in an embodiment where t_{X} is less than t_{Y}, that is, an embodiment where the layer X is thinner than the layer Y. Such a surface protective sheet substrate can combine higher levels of inhibition of curling and suppression of adhesion marks.

The tensile elastic modulus (E_{X}) of the resin composition constituting the layer X and the tensile elastic modulus (E_{Y}) of the resin composition constituting the layer Y may be the same or different. The art disclosed herein can be implemented preferably in an embodiment having different E_{X} and E_{Y} values. It can also be implemented preferably in an embodiment where E_{Y} is smaller than E_{X}. When a surface protective sheet substrate with E_{Y} being smaller than E_{X} is used in an embodiment of a surface protective sheet comprising a PSA layer on the surface of the layer Y, the anchoring at the interface between the PSA layer and the substrate may increase. Thus, such a surface protective sheet may have a greater ability to suppress adhesion marks.

In the surface protective sheet substrate in an embodiment further having an intermediate layer in addition to the layer X and layer Y, the tensile elastic modulus (or “E_{Z}” hereinafter in MPa) of the resin composition constituting the intermediate layer is not particularly limited. Form the standpoint of increasing the flexibility of the surface protective sheet substrate, it may be preferable to use an intermediate layer having a tensile elastic modulus (E_{Z}) smaller than both E_{X} and E_{Y}. A highly flexible surface protective sheet substrate is preferable since a surface protective sheet comprising the substrate may have greater surface conformability. When the surface protective sheet substrate comprises two or more intermediate layers, E_{Z} refers to the average tensile elastic modulus of all the intermediate layers.

From the standpoint of balancing the ease of molding the surface protective sheet substrate and the surface conformability of a surface protective sheet constituted with the substrate, it is preferable that the subtraction of E_{Z} from E_{Y} (E_{Y}−E_{Z}) is 150 MPa or greater (more preferably 200 MPa or greater, or yet more preferably 220 MPa or greater).

In an embodiment of the surface protective sheet substrate disclosed herein, the substrate has an overall thickness smaller than 60 μm. The overall thickness of the substrate is more preferably 10 μm or larger, but 55 μm or smaller, or yet more preferably 15 μm or larger, but 50 μm or smaller. For instance, it is preferably 30 μM or larger, but 45 μm or smaller. When the overall thickness of the substrate is equal to or smaller than the aforementioned upper limit, it is advantageous from the standpoint of possibly ensuring a necessary thickness of the PSA layer in a surface protective sheet comprising the substrate. When the overall thickness of the substrate is equal to or larger than the aforementioned lower limit, a surface protective sheet comprising the substrate may be advantageous from the standpoint of the surface conformability and handling properties.

In an embodiment of the surface protective sheet substrate disclosed herein, the total thickness (t_{X}+t_{Y}) of the thickness (t_{X}) of the layer X and the thickness (t_{Y}) of the layer Y is preferably 20% or more, but 80% or less (more preferably 35% or more, but 75% or less, yet more preferably 45% or more, but 70% or less, typically 47% or more, but 60% or less, e.g. 48% or more, but 55% or less) of the overall thickness of the substrate. A surface protective sheet substrate with t_{X}+t_{Y} being in the aforementioned range readily allows taking advantage of the multi-layer structure. For instance, with respect to a surface protective sheet substrate with t_{X}+t_{Y} being equal to or below the aforementioned upper limit, the entire substrate can be surely endowed with flexibility. Thus, a surface protective sheet using the substrate may have greater surface conformability on an adherend. A surface protective sheet with t_{X}+t_{Y} being equal to or above the aforementioned lower limit may have a greater ability to suppress adhesion marks.

In an embodiment of the surface protective sheet substrate disclosed herein, the intermediate layer preferably has a thickness of 10 μm or larger, but smaller than 30 μm. The thickness of the intermediate layer is more preferably 12 μm or larger, but 25 μm or smaller, or yet more preferably 15 μm or larger, but 22 μm or smaller. A surface protective sheet substrate with the thickness of the intermediate layer being equal to or larger than the aforementioned lower limit readily allows taking advantage of the multi-layer structure, whereby, for instance, the flexibility of the entire substrate may increase. A surface protective sheet substrate with the thickness of the intermediate layer being equal to or smaller than the aforementioned upper limit is advantageous from the standpoint of making the substrate thinner.

To the surface protective sheet substrate disclosed herein, a suitable component (additive) allowable for inclusion in the substrate can be added as necessary. Examples of such additives include an inorganic weathering stabilizer, organic weathering stabilizer, slip agent, anti-blocking agent, etc.

In a preferable embodiment, at least one resin layer constituting the substrate (i.e. one, two or more layers selected from the layer X, the layer Y and the intermediate layer which is an optional constituent) comprises an inorganic weathering stabilizer. In a substrate having an intermediate layer, a constitution where the intermediate layer comprises an inorganic weathering stabilizer can be preferably used. When the intermediate layer comprises multiple layers, at least one of the layers (or possibly all the layers) preferably comprises an inorganic weathering stabilizer. In a preferable embodiment, all the layers constituting the substrate comprise an inorganic weathering stabilizer at the same or different concentrations. Herein, the term inorganic weathering stabilizer refers to an inorganic material (typically an inorganic powder) capable of increasing the weatherability of the surface protective sheet. Such an inorganic material may be perceived as an inorganic pigment or as a filler.

Preferable examples of inorganic weathering stabilizer include inorganic powders such as a titanium oxide (typically of the rutile type), zinc oxide, calcium carbonate, etc. For instance, for a purpose that demands long-term outdoor weatherability (e.g. a protective sheet for use on exterior paint coats of large articles such as building materials, etc.), a titanium oxide can be preferably used. For instance, a highly weatherable titanium oxide wherein the surfaces of titanium oxide particles are coated with Si-Al₂O₃, etc., can be preferably used.

The amount of inorganic weathering stabilizer added can be suitably selected in view of the level of the effect obtainable by its addition or the ease of substrate molding in accordance with the molding method (extrusion molding, cast molding, etc.) of the resin sheet. It is usually preferable that the amount of inorganic weathering stabilizer added (when several species are added, their total amount) is about 2 to 30% by weight (more preferably about 4 to 20% by weight, e.g. 5 to 12% by weight) of the entire substrate. When several layers include an inorganic weathering stabilizer, at least one of the layers (or possibly all the layers) preferably satisfies the aforementioned amount added.

These additives can be used solely as one species or in combination of two or more species. As for the entire substrate, additive(s) can be added in an amount approximately the same as a typical amount used in the field of resin sheets for use as substrates and the like in surface protective sheets (e.g. paint surface protective sheets, etc.). The type(s) and amount(s) of additive(s) added to the respective resin layers constituting the substrate may be different from layer to layer, or may be the same among some or all of the layers.

### [PSA Layer]

The PSA layer preferably included in the surface protective sheet disclosed herein may comprise, as its base polymer(s), one, two or more species among various polymers commonly known in the PSA field, such as a rubber-based polymer, acrylic polymer, polyester-based polymer, urethane-based polymer, polyetherbased polymer, silicone-based polymer, polyamide-based polymer, fluorine-based polymer, etc.

In this description, the term “base polymer” of a PSA refers to the primary component among rubbery polymers contained in the PSA. The term rubbery polymer refers to a polymer that exhibits rubber elasticity in a room temperature range. In this description, the term “primary component” refers to a component accounting for more than 50% by weight of the content unless otherwise indicated.

In a preferable embodiment, the PSA layer is a rubber-based PSA layer formed from a PSA composition comprising a rubber-based polymer as a base polymer (the primary component among polymers). Examples of the base polymer in a rubber-based PSA include various rubber-based polymers such as a natural rubber; styrene-butadiene rubber (SBR); polyisoprene; butyl rubbers such as a regular butyl rubber, chlorinated butyl rubber, brominated butyl rubber, etc.; isobutylene-based polymers such as a polyisobutylene, isoprene-isobutylene copolymer or a modified product thereof, etc.; an A-B-A block copolymer rubber and a hydrogenation product thereof, such as a styrene-butadiene-styrene block copolymer rubber (SBS), styrene-isoprene-styrene block copolymer rubber (SIS), styrene-vinylisoprene-styrene block copolymer rubber (SVIS), styrene-ethylene-butylene-styrene block copolymer rubber (SEBS) which is a hydrogenation product of SBS, styrene-ethylene-propylene-styrene block copolymer rubber (SEPS) which is a hydrogenation product of SIS; and the like.

The art disclosed herein can be preferably applied to a surface protective sheet comprising a PSA layer formed of a non-crosslink-type PSA. Examples of the non-crosslink-type PSA include a PSA comprising an ABA-type block copolymer rubber or its hydrogenation product as the base polymer, a PSA comprising an isobutylene-based polymer as the base polymer, and the like. Among these, a preferable PSA layer is constituted with a non-crosslink-type PSA (a polyisobutylene-based PSA) formed from a PSA composition comprising an isobutylene-based polymer as the base polymer. For instance, when the adherend is an article comprising a paint layer such as a painted steel plate, etc., since a polyisobutylene-based PSA has a solubility parameter value (SP value) that is largely different from that of the paint layer, transfer of a substance is unlikely to occur between the two and the adherend surface is unsusceptible to the occurrence of adhesion marks. Such a PSA layer is highly elastic and is preferable as a PSA (removable PSA) for use in a PSA sheet used in an embodiment where it is eventually removed, such as a surface protective sheet.

The isobutylene-based polymer may be an isobutylene homopolymer (homoisobutylene) or a copolymer based on isobutylene as a primary monomer. Examples of the copolymer include a copolymer of isobutylene and normal butylene, copolymer of isobutylene and isoprene (regular butyl rubber, chlorinated butyl rubber, brominated butyl rubber, partially crosslinked butyl rubber, etc.), vulcanized products or modified products of these (e.g. products modified with a functional group such as hydroxyl group, carboxyl group, amino group, epoxy group, etc.), and the like. From the standpoint of the stability of adhesive strength (e.g., unsusceptibility to an excessive increase in the adhesive strength due to aging or a thermal history), preferably usable isobutylene-based polymers include a homoisobutylene and an isobutylene-normal butylene copolymer. In particular, a homoisobutylene is preferable.

The molecular weight of such an isobutylene-based polymer is not particularly limited. For instance, an isobutylene-based polymer having a weight average molecular weight (Mw) of about 1×10⁴ to 150×10⁴ can be suitably selected and used. Two or more isobutylene-based polymers having individually different Mw values may be used in combination. As a whole, the isobutylene-based polymer for use has a Mw value in a range of preferably about 10×10⁴ to 150×10⁴ (more preferably about 30×10⁴ to 100×10⁴).

The isobutylene-based polymer may be an isobutylene-based polymer (a masticated product) obtained from an isobutylene-based polymer with a higher molecular weight via a mastication process to lower the molecular weight (preferably to lower the weight average molecular weight to the preferable range described above). The mastication process can be preferably carried out so as to obtain an isobutylene-based polymer having a Mw value equal to approximately 10% to 80% of the pre-mastication value. It is also preferable to carry out the process so as to obtain an isobutylene-based polymer having a number average molecular weight (Mn) of about 10×10⁴ to 40×10⁴. Such a mastication process can be performed based on the contents of Japanese Patent No. 3878700.

The polyisobutylene-based PSA may comprise, as its base polymer(s), one, two or more species selected from these isobutylene-based polymers. In addition to the base polymer, the polyisobutylene-based PSA may comprise, as a secondary component, a non-polyisobutylene-based polymer. Examples of such a polymer include a poly(meth)acrylic acid ester, polybutadiene, polystyrene, polyisoprene, polyurethane, polyacrylonitrile, polyamide, etc. The non-polyisobutylene-based polymer content is usually preferably 10% by weight or less of the total polymer content in the polyisobutylene-based PSA. The PSA may be essentially free of a non-polyisobutylene-based polymer.

The PSA preferably used in the surface protective sheet disclosed herein may contain as necessary suitable components (additives) allowable for inclusion in the PSA. Examples of such additives include a softener, tackifier, release agent, etc. Other examples include an inorganic weathering stabilizer such as a pigment, filler, etc.; and an organic weathering stabilizer such as a light stabilizer (radical scavenger), UV absorber, antioxidant, etc. These additives can be used solely or in combination of two or more species. The amount of additive(s) added can be, for instance, about the same as a usual amount used in the field of PSA for use in surface protective sheets.

Examples of a preferably usable tackifier include an alkylphenol resin, terpene phenol resin, epoxy-based resin, coumarone-indene resin, rosin-based resin, terpene-based resin, alkyd resin, hydrogenation products thereof, and the like. When a tackifier is used, its amount added can be, for instance, about 0.1 to 50 parts by weight relative to 100 parts by weight of the base polymer. It is usually preferable that the amount added relative to 100 parts by weight of the base polymer is 0.1 to 5 parts by weight. Alternatively, the PSA may have a composition essentially free of a tackifier.

Examples of softener include a rubber-based material having a low molecular weight, process oil (typically a paraffin-based oil), petroleum-based softener, epoxy-based compound, and the like. Examples of pigments and fillers include inorganic powders such as titanium oxide, zinc oxide, calcium oxide, magnesium oxide, silica and the like. Examples of a release agent include silicone-based release agents, paraffin-based release agents, polyethylene wax, acrylic polymers and the like. When using a release agent, its amount can be, for instance, about 0.01 to 5 parts by weight relative to 100 parts by weight of the base polymer. Alternatively, the PSA may have a composition essentially free of such a release agent. As the light stabilizer, UV absorber and antioxidant, the same kinds as those for the substrate and the like can be used.

In the art disclosed herein, the thickness of the PSA layer is not particularly limited and can be suitably selected in accordance with the purpose. It is usually suitably about 100 μm or smaller (e.g. about 2 μm to about 100 μm), preferably about 3 μm to about 30 μm, or more preferably about 5 μm to about 20 μm.

The PSA layer in the art disclosed herein may be formed from, for instance, a water-dispersed PSA composition, solvent-based PSA composition, hot-melt PSA composition or active energy ray-curable PSA composition. The term water-dispersed PSA composition refers to a PSA composition in a form where a PSA (PSA layer-forming components) is dispersed in an aqueous solvent. The term aqueous solvent refers to water or a solvent comprising water as the primary component. The term solvent-based PSA composition refers to a PSA composition comprising a PSA in an organic solvent.

The PSA layer can be formed based on a method for forming PSA layers known in the PSA sheet field. For instance, can be preferably employed a method (direct method) where a PSA layer is formed by obtaining (by production, purchase, etc.) a PSA composition in which PSA layer-forming ingredients including a polymer and additive(s) added as necessary are dissolved or dispersed in a suitable solvent, directly providing (typically applying) the composition to a substrate and allowing the composition to dry. Alternatively, can be employed a method (transfer method) where a PSA layer is transferred to a substrate, with the PSA layer having being pre-formed on a highly releasable surface (e.g., a release liner surface, the back face of a substrate that has been processed with a release treatment, etc.) by applying the PSA composition thereto and allowing the composition to dry. While the PSA layer is typically formed to have a continuous phase, it can be formed to have a regular or random pattern of dots, stripes, etc., depending on the purpose and intended use.

Since the occurrence of curling is effectively inhibited, the surface protective sheet substrate disclosed herein can also be preferably used in a surface protective sheet produced by a method that comprises a step of drying a PSA composition comprising a solvent or dispersion medium on the surface protective sheet substrate (i.e. a direct method). Accordingly, in another aspect, the present invention provides a method for producing a surface protective sheet, the method comprising: applying a PSA composition comprising a solvent or dispersion medium to the surface protective sheet substrate, and drying the applied PSA composition on the surface protective sheet substrate to form a PSA layer. Typical examples of the PSA composition comprising a solvent or a dispersion medium include a solvent-based PSA composition and a water-dispersed PSA composition (typically an emulsion-based PSA composition). The concept of the PSA composition comprising a solvent includes also an active energy ray-curable PSA composition comprising a small amount of an organic solvent, for instance, for viscosity adjustment or like purpose.

### Examples

Several worked examples relating to the present invention are described below, but the present invention is not intended to be limited to these examples. In the description below, “parts” and “%” are based on weight unless otherwise specified.

The following starting materials were used for fabricating surface protective sheets in the respective examples below.

H-PP: homopolypropylene (available from Japan Polypropylene Corporation, trade name “NOVATEC PP FY4”, MFR=5.0)

B-PP: block polypropylene (available from Japan Polypropylene Corporation, trade name “NOVATEC PP BC8”, MFR=1.8)

R-PP: random polypropylene (available from Japan Polypropylene Corporation, trade name “NOVATEC PP FX4E”, MFR=5.3)

PE: linear low density polyethylene (LLDPE) (available from Japan Polypropylene Corporation, trade name “KERNEL KF380”; density d=0.925 g/cm³)

TiO₂: Si·Al₂O₃-coated rutile titanium dioxide (available from Ishihara Sangyo Kaisha, Ltd., trade name “TIPAQUE CR-95”)

### [Fabrication of Surface Protective Sheet Substrates]

Mixtures of starting materials at weight ratios shown in Table 1 below were melted and kneaded with a three-layer co-extrusion T-die film forming machine to form films so that the respective layers had thickness values as shown in Table 2, whereby surface protective sheet substrates measuring 40 μm in overall thickness were fabricated. The thicknesses of the respective layers (layer X, intermediate layer, and layer Y) constituting the substrate according to each example were determined by electron microscope observations. To each of the layer X, intermediate layer and layer Y, besides the materials shown in Table 1, 0.2 part of a weathering stabilizer (available from Nihon Ciba-Geigy K. K., trade name “CHIMASSORB® 944FDL”) was added to 100 parts of the materials shown in Table 1. With respect to Example 14, no surface protective sheet substrate was produced due to failed film formation.

TABLE 1

| | Resin composition (parts) | | |
|---|---|---|---|
| | Layer X | Intermediate layer | Layer Y |
| | H-PP/B-PP/R-PP/PE | H-PP/B-PP/PE/TiO₂ | H-PP/B-PP/R-PP/PE |
| Ex. 1 | 50/20/0/30 | 20/0/68/12 | 50/20/0/30 |
| Ex. 2 | 50/30/0/20 | 20/0/68/12 | 50/20/0/30 |
| Ex. 3 | 50/20/0/30 | 20/0/68/12 | 40/20/0/40 |
| Ex. 4 | 50/20/0/30 | 20/0/68/12 | 40/20/0/40 |
| Ex. 5 | 50/20/0/30 | 20/0/68/12 | 40/20/0/40 |
| Ex. 6 | 40/20/0/40 | 20/0/68/12 | 50/30/0/20 |
| Ex. 7 | 40/20/0/40 | 20/0/68/12 | 50/30/0/20 |
| Ex. 8 | 0/0/40/40 | 38/20/30/12 | 0/0/40/40 |
| Ex. 9 | 0/0/60/40 | 20/0/68/12 | 50/30/0/20 |
| Ex. 10 | 0/0/40/40 | 38/20/30/12 | 50/30/0/20 |
| Ex. 11 | 0/0/40/40 | 38/20/30/12 | 50/30/0/20 |
| Ex. 12 | 50/20/0/30 | 20/0/68/12 | 40/20/0/40 |
| Ex. 13 | 40/20/0/40 | 20/0/68/12 | 60/30/0/10 |
| Ex. 14 | 20/0/0/80 | 20/0/68/12 | 40/20/0/40 |

TABLE 2

| | | Ex. | | | | | | | | | | | | | |
|---|---|---|---|---|---|---|---|---|---|---|---|---|---|---|---|
| | | 1 | 2 | 3 | 4 | 5 | 6 | 7 | 8 | 9 | 10 | 11 | 12 | 13 | 14 |
| Thickness of | X | 10 | 10 | 10 | 8 | 6 | 10 | 12 | 12 | 14 | 14 | 8 | 12 | 10 | 10 |
| layer | ITM. | 20 | 20 | 20 | 20 | 20 | 20 | 20 | 20 | 20 | 20 | 20 | 20 | 20 | 20 |
| (μm) | Y | 10 | 10 | 10 | 12 | 14 | 10 | 8 | 12 | 6 | 6 | 12 | 8 | 10 | 10 |
| Tensile elastic | X | 685 | 740 | 685 | 685 | 685 | 610 | 610 | 440 | 440 | 440 | 440 | 685 | 610 | 350 |
| modulus | ITM. | 370 | 370 | 370 | 370 | 370 | 370 | 370 | 649 | 359 | 649 | 649 | 370 | 370 | 370 |
| (MPa) | Y | 685 | 685 | 610 | 610 | 610 | 740 | 740 | 440 | 740 | 740 | 715 | 610 | 785 | 610 |

| | | | | | | | | | | | | | | |
|---|---|---|---|---|---|---|---|---|---|---|---|---|---|---|
| t_{X} · E_{X}/t_{Y} · E_{Y} | 1.0 | 1.1 | 1.1 | 0.7 | 0.5 | 0.8 | 1.2 | 0.7 | 1.4 | 1.4 | 0.4 | 1.7 | 0.8 | 0.6 |
| Curling inhibition | E | E | E | E | E | E | E | E | G | G | P | P | E | — |
| Direction of curling | — | — | — | — | — | — | — | — | X | X | X | Y | — | — |
| Suppression of | S | S | S | S | S | S | S | S | S | S | S | S | N | — |
| adhesion marks | | | | | | | | | | | | | | |

ITM: intermediate

### [Fabrication of PSA Layers]

100 parts of a polyisobutylene and 0.4 part of a p-tert-octylphenol resin (available from Sumitomo Durez Co., Ltd.; trade name “DUREZ 19900”) as a tackifier were dissolved in an organic solvent to prepare a PSA solution (solvent-based PSA composition). As the polyisobutylene, trade names “OPPANOL B-80” and “OPPANOL B-12SFN” available from BASF Corporation were used at a weight ratio of 75:25. The PSA solution was applied to the layer Y side surface of the surface protective sheet substrate obtained above according to each example and allowed to dry by heating at 100° C. for one minute to form a 10 μm thick PSA layer. In such a manner, surface protective sheets according to Examples 1 to 13 were fabricated.

### [Measurement of Tensile Elastic Moduli]

With respect to surface protective sheet substrates according to Examples 1 to 14, the respective layers constituting the substrates were subjected to tensile elastic modulus measurements by the following method.

The surface protective sheet substrate according to each example has a three-layer structure. To measure the tensile elastic moduli of the resin compositions constituting the respective layers in such a substrate, 40 μm thick single-layer resin films having the same compositions as the resin compositions of these layers were fabricated as measurement samples, respectively. More specifically, the starting materials were mixed at the weight ratio shown in Table 1, the mixture was melted and kneaded with a single-layer extrusion T-die film forming machine, and a 40 μm thick single-layer film was fabricated.

Each single-layer film was cut to 100 mm long by 25 mm wide pieces. Using a precision universal tester (available from Shimadzu Corporation, model name “AUTOGRAPH AG-IS”), a cut piece was stretched at a chuck distance of 50 mm at a tensile speed of 300 mm/min, and the change in stress was recorded until plastic deformation of the film occurred to obtain a stress-strain curve. The tensile elastic modulus was determined by linear regression of the curve between two specified strain points, namely at ε₁=1 and at ε₂=2. Three test pieces cut out from different locations were subjected to the measurement and their average value was used as the tensile elastic modulus. The measurement was performed based on JIS K 7161, at 23° C. at 50% RH.

Table 2 also shows the tensile elastic moduli measured by this method about the respective layers constituting the surface protective sheet substrate. Based on the tensile elastic moduli determined in this test, the products of “thickness x elastic modulus” were computed for the respective layers and summarized in Table 3.

TABLE 3

| | Thickness × Tensile elastic modulus (N/m) | | |
|---|---|---|---|
| | Layer X | Intermediate layer | Layer Y |
| Ex. 1 | 6850 | 7409 | 6850 |
| Ex. 2 | 7400 | 7409 | 6850 |
| Ex. 3 | 6850 | 7409 | 6100 |
| Ex. 4 | 5480 | 7409 | 7320 |
| Ex. 5 | 4110 | 7409 | 8540 |
| Ex. 6 | 6100 | 7409 | 7400 |
| Ex. 7 | 7320 | 7409 | 5920 |
| Ex. 8 | 3520 | 12977 | 5280 |
| Ex. 9 | 6160 | 7180 | 4440 |
| Ex. 10 | 6160 | 12977 | 4440 |
| Ex. 11 | 3520 | 12977 | 8580 |
| Ex. 12 | 8220 | 7409 | 4880 |
| Ex. 13 | 6100 | 7409 | 7850 |
| Ex. 14 | 3500 | 7400 | 6100 |

### [Inhibition of Curling]

The surface protective sheet substrate according to each example was cut to 20 cm long by 10 cm wide pieces. A cut piece was oriented so that its length direction was in the vertical direction relative to the ground and suspended by fastening the top portion.

The surface protective sheet substrate in this state was stored in an oven at 100° C. for one minute. Subsequently, through the oven window, the surface protective sheet substrate was visually inspected for the presence of any rising edge, and the extent of the rising from the initial position caused by curling was measured with a ruler. By this test, the ability of the surface protective sheet substrate to inhibit curling was evaluated in the following three grades: E (excellent curling inhibition) when less than 2 mm; G (good curling inhibition) when 2 mm or greater, but less than 5 mm; and P (poor curling inhibition) when 5 mm or greater. The results are shown in Table 2. With respect to an example yielding a rising of 2 mm or greater, the direction of curling is also indicated in Table 2.

### [Suppression of Adhesion Marks]

Each surface protective sheet was cut to 70 mm long and 50 mm wide to prepare test pieces. As an adherend, a stainless steel plate (SUS 430 No. 4) was obtained and a cut test piece was press-bonded to the plate. The press-bonding was carried out by moving a 2 kg roller back and forth once. This was stored at 70° C. for one week. Subsequently, in an environment at 23° C. at 50% RH, using a high-speed peel tester, the test piece was peeled away from the adherend at a peel angle of about 180° at a peeling rate of 30 m/min. During this operation, the behavior of the PSA at the interface between the adherend surface and the PSA layer was visually observed and the presence of adhesion marks was evaluated into the following two grades: S (suppressed) when no adhesion marks were observed; and N (not suppressed) when some adhesion marks were observed. With respect to the surface protective sheet substrate according to each example, three test pieces were subjected to the measurement. Even when adhesion marks were observed with only one of the pieces, a grade of “N” was assigned. The results are shown in Table 2.

As shown in Table 2, even after stored at a temperature of 100° C. for one minute, curling was evidently inhibited in the surface protective sheet substrates according to Examples 1 to 10. In particular, the surface protective sheet substrates according to Examples 1 to 8 were endowed with greater curling inhibition. With respect to the surface protective sheets according to Examples 1 to 10, adhesion marks were evidently suppressed to great degree.

On the contrary, in the surface protective sheet substrates according to Examples 9 to 12, the curling inhibition tests resulted in curling in the direction toward layers with smaller tensile elastic moduli, respectively. As for the surface protective sheet substrate according to Example 13, the curling was inhibited, but the surface protective sheet using this substrate resulted in poor suppression of adhesion marks.

Although specific embodiments of the present invention have been described in detail above, these are merely for illustrations and do not limit the scope of the claims. The art according to the claims includes various modifications and changes made to the specific embodiments illustrated above.

What is claimed is:

1. A surface protective sheet substrate, wherein
the substrate comprises a polyolefin resin which accounts for more than 50% by weight of the entire substrate,
the substrate comprises a layer X that is a resin layer constituting a first surface of the substrate and a layer Y that is a resin layer constituting the second surface of the substrate,
the layer X is constituted with a resin composition having a tensile elastic modulus (E_{X} (MPa)) of 400 MPa or greater, but 750 MPa or less,
the layer Y is constituted with a resin composition having a tensile elastic modulus (E_{Y} (MPa)) of 400 MPa or greater, but 750 MPa or less, and
when the layer X has a thickness t_{X} (μm) and the layer Y has a thickness t_{Y} (μm), the substrate satisfies the next inequality:
0.5≦t_{X}·E_{X}/t_{Y}·E_{Y}≦1.5

2. The surface protective sheet substrate according to claim 1, further satisfying the following inequalities:
3.5×10³ N/m≦t_{X}·E_{X}≦10×10³ N/m; and
3.5×10³ N/m≦t_{Y}·E_{Y}≦10×10³ N/m

3. The surface protective sheet substrate according to claim 1, having a difference of 1 μm or larger, but 20 μm or smaller between the thickness (t_{X}) of the layer X and the thickness (t_{Y}) of the layer Y.

4. The surface protective sheet substrate according to claim 1, wherein the thickness (t_{X}) of the layer X is smaller than the thickness (t_{Y}) of the layer Y.

5. The surface protective sheet substrate according to claim 1, wherein
the substrate comprises an intermediate layer between the layer X and the layer Y, and
the intermediate layer is constituted with a resin composition having a tensile elastic modulus smaller than both the E_{X} and the E_{Y}.

6. The surface protective sheet substrate according to claim 1, wherein at least either the layer X or the layer Y comprises a linear low density polyethylene.

7. The surface protective sheet substrate according to claim 1, wherein the substrate has an overall thickness smaller than 60 μm.

8. The surface protective sheet substrate according to claim 1, wherein the thickness (t_{X}) of the layer X and the thickness (t_{Y}) of the layer Y yield a total thickness accounting for 35% or more, but 75% or less of the overall thickness of the substrate.

9. A surface protective sheet comprising the surface protective sheet substrate according to claim 1 and a pressure-sensitive adhesive layer placed on a first surface of the surface protective sheet substrate.

10. The surface protective sheet according to claim 9, wherein the pressure-sensitive adhesive layer is formed by a method that comprises a step of drying a pressure-sensitive adhesive composition comprising a solvent or dispersion medium on the surface protective sheet substrate.

11. The surface protective sheet substrate according to claim 2, having a difference of 1 μm or larger, but 20 μm or smaller between the thickness (t_{X}) of the layer X and the thickness (t_{Y}) of the layer Y.

12. The surface protective sheet substrate according to claim 2, wherein the thickness (t_{X}) of the layer X is smaller than the thickness (t_{Y}) of the layer Y.

13. The surface protective sheet substrate according to claim 2, wherein
the substrate comprises an intermediate layer between the layer X and the layer Y, and
the intermediate layer is constituted with a resin composition having a tensile elastic modulus smaller than both the E_{X} and the E_{Y}.

14. The surface protective sheet substrate according to claim 2, wherein at least either the layer X or the layer Y comprises a linear low density polyethylene.

15. The surface protective sheet substrate according to claim 2, wherein the substrate has an overall thickness smaller than 60 μm.

16. The surface protective sheet substrate according to claim 2, wherein the thickness (t_{X}) of the layer X and the thickness (t_{Y}) of the layer Y yield a total thickness accounting for 35% or more, but 75% or less of the overall thickness of the substrate.

17. A surface protective sheet comprising the surface protective sheet substrate according to claim 2 and a pressure-sensitive adhesive layer placed on a first surface of the surface protective sheet substrate.

18. The surface protective sheet substrate according to claim 3, wherein the thickness (t_{X}) of the layer X is smaller than the thickness (t_{Y}) of the layer Y.

19. The surface protective sheet substrate according to claim 3, wherein
the substrate comprises an intermediate layer between the layer X and the layer Y, and
the intermediate layer is constituted with a resin composition having a tensile elastic modulus smaller than both the E_{X} and the E_{Y}.

20. The surface protective sheet substrate according to claim 3, wherein at least either the layer X or the layer Y comprises a linear low density polyethylene.
